(19) United States
(12) Patent Application Publication
(10) Pub. No.: US 2012/0037766 A1
(43) Pub. Date: Feb. 16, 2012

(54) CABLE MANAGEMENT APPARATUS

(75) Inventors: Kenneth J. Buras, JR., Spring, TX (US); Brian Roderman, Plano, TX (US); David Singer, Austin, TX (US)

(73) Assignee: The Wiremold Company, West Hartford, CT (US)

(21) Appl. No.: 12/853,388

(22) Filed: Aug. 10, 2010

(51) Int. Cl. F16L 3/22; F16B 47/00; F16L 3/08

(52) U.S. Cl. 248/68.1; 248/65

(57) ABSTRACT

A cable management apparatus includes a base mountable on a wall or other surface and a flexible elastic loop having a hanging loop portion adapted to hang on the base for supporting one or more cables through the flexible elastic loop. The base may include a post extending outwardly for supporting the flexible elastic loop on the post. The cable management apparatus may also include a removable grooved collar for receiving the hanging loop portion of the flexible elastic loop. The removable grooved collar surrounds the post and slides onto the post.

### FIELD OF THE INVENTION

The present invention relates to an apparatus for managing cables and, more particularly, to an apparatus for bundling and hanging cables from a surface.

### BACKGROUND OF THE INVENTION

Organizing electrical cables is necessary to prevent unattractive and disorderly exposed cables, cords and wires and to prevent cables from tangling. However, the process of organizing cables is time consuming and laborious. Conventional methods for organizing cables include unplugging all cables from all electrical power sources and equipment and untangling and separating the cables and wires. Next, the cables are threaded through a cable track according to the desired path of the cables, leaving ends free. Once threaded through the cable track, the cables may be reconnected to the electrical power source and equipment such as televisions, audio and visual equipment, computers, and such.

This method of organizing cables is disadvantageous for several reasons. As noted above, the process of organizing cables is labor-intensive and time consuming. Furthermore, cable tracks can be bulky and unattractive, and often do not fully obscure the cables from view. Finally, adding a cable to the cable track or removing a cable from the cable track requires time-consuming disassembly of the entire cable track assembly by hand.

Therefore, there exists a need for an improved device for organizing and hanging cables to obscure cables from view. There also exists a need for an improved device for organizing and bundling cables to allow for easy addition of individual cables to bundles and removal of individual cables from bundles.

### SUMMARY OF THE INVENTION

According to the present invention, a cable management apparatus comprises a base mountable on a surface, a grooved collar slidably received on a post extending outwardly from the base, and a flexible elastic loop threaded through the collar for supporting a bundle of cables, wires, or cords.

Also according to the present invention, the post of the base is axially apertured to receive a fastener for permanently attaching to the base on a surface such as a wall or furniture.

The foregoing and other advantages of the present invention become more apparent in light of the present invention described in the following detailed description of the exemplary embodiments thereof, as illustrated in the accompanying drawings.

### BRIEF DESCRIPTION OF THE DRAWINGS

FIG. 1 is a perspective view of a cable management apparatus for organizing and bundling cables having a base, a grooved collar, and a flexible elastic loop, according to the present invention;

FIG. 2 is a perspective view of the base of FIG. 1 being mounted to a wall by inserting a fastener through an axial aperture in the base;

FIG. 3 is a front exploded view of the grooved collar of FIG. 1;

FIG. 4 a rear exploded view of the grooved collar of FIG. 1;

FIG. 5 is a front exploded view of the grooved collar engaging the flexible elastic loop of FIG. 1;

FIG. 6 is a side view of the grooved collar of FIG. 1;

FIG. 7 is a perspective view the cable management apparatus of FIG. 1 being tied around a bundle of cables;

FIG. 8 is a perspective view of the base of FIG. 1 mounted to the wall by pressure sensitive adhesive between the wall and the base; and

FIG. 9 is a perspective view of the cable management apparatus of FIG. 1 mounted to furniture.

### DETAILED DESCRIPTION OF PREFERRED EMBODIMENTS

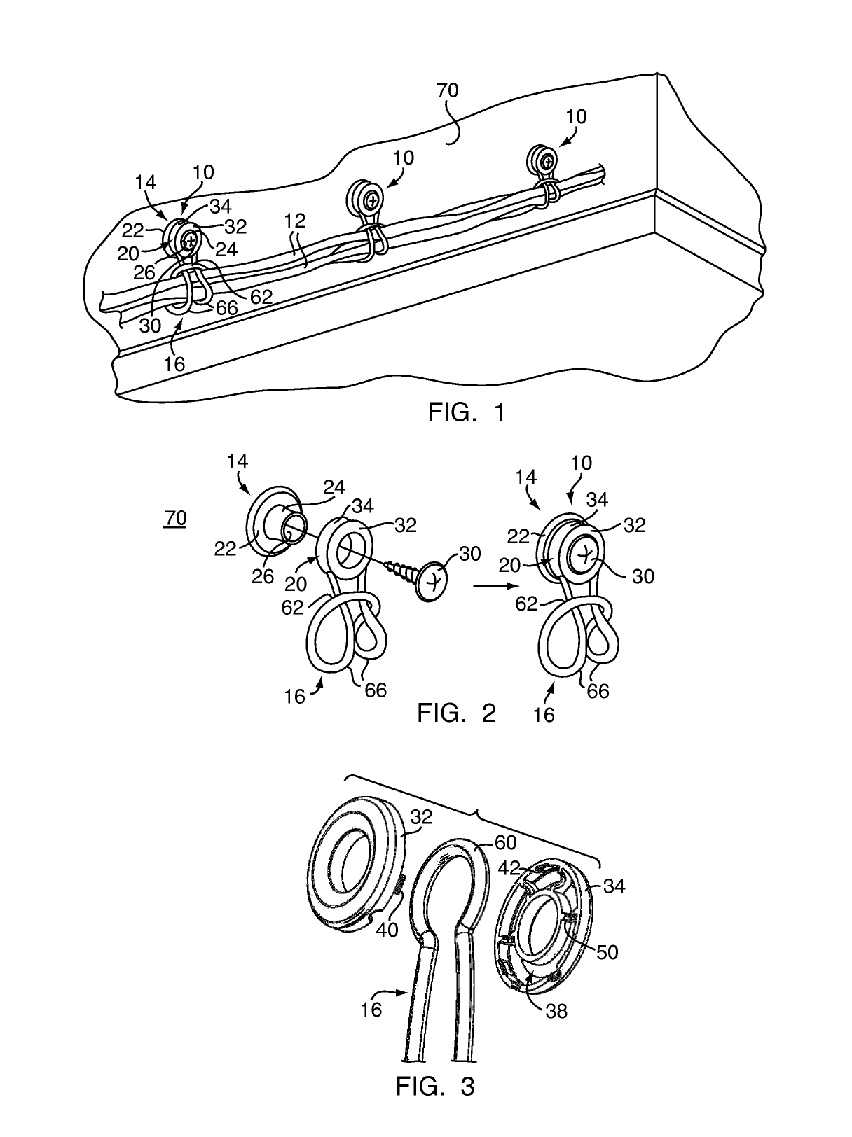

Referring to FIG. 1, a cable management apparatus 10 for bundling cables 12 includes a base 14, a flexible elastic loop 16, and a grooved collar 20. As used herein, the term “cable” is defined as any elongated object adapted to being bundled including, but not limited to, cables, wires, cords, and the like.

Referring to FIG. 2, the base 14 includes a backing 22 and a post 24 extending outwardly from the backing 22 and having an axial aperture 26 for receiving a fastener 30 through the aperture 26.

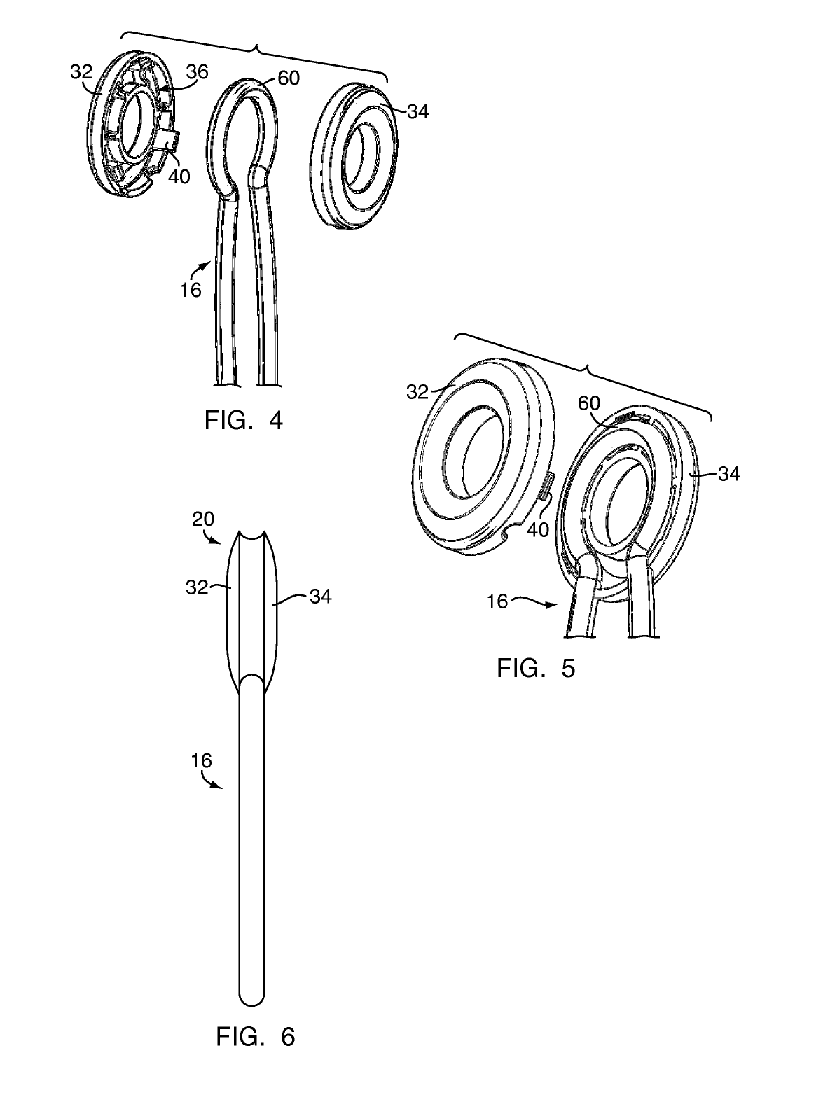

Referring to FIGS. 3-6, the grooved collar 20 includes a pair of spaced flanges 32, 34 defining grooves 36, 38, therein, respectively, for receiving the flexible elastic loop 16. Together, grooves 36 and 38 form an interior cavity 39. The first flange 32 of the collar 20 includes one or more tabs 40 and the second flange 34 includes one or more receptacles 42 adapted to receive the tabs 40 of the first flange 32. The first flange 32 and second flange 34 also include one or more ribs 50 to support the flexible elastic loop 16 within the interior cavity 39. The ribs 50 may grip the flexible elastic loop 16 to prevent the flexible elastic loop 16 from moving within the interior cavity 39. Optionally, the first flange 32 and the second flange 34 may be ultrasonically welded together for additional strength. As may be appreciated, the first flange 32 and the second flange 34 may be permanently joined by any available means.

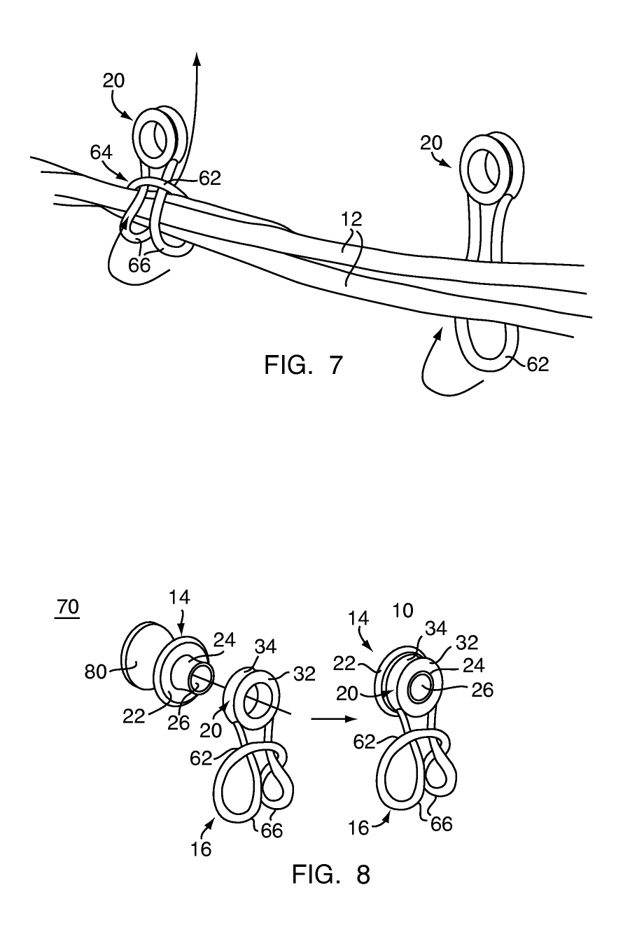

Referring to FIGS. 5 and 7, the flexible elastic loop 16, when relaxed, includes a hanging loop portion 60 that is received within the interior cavity 39 of the grooved collar 20 and a tightening loop portion 62. The flexible elastic loop 16 may be tied into a slipknot configuration 64, in which the tightening loop portion 62 is wrapped circumferentially around a bundle of cables 12 as the grooved collar 20 is inserted into the tightening loop portion 62. In this configuration, a pair of aligned, closed support loops 66 are formed which support the bundle of cables 12.

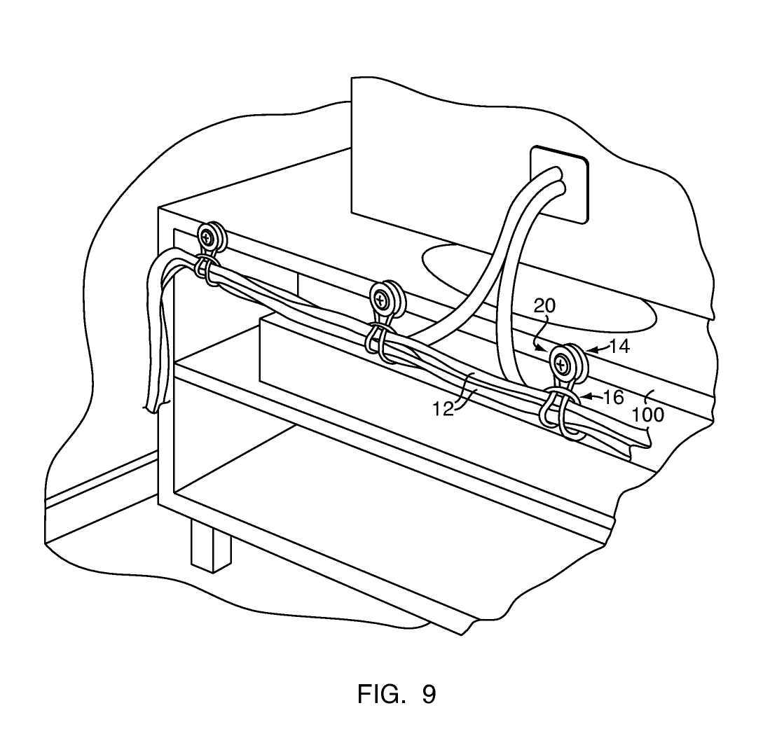

In operation, the grooved collar 20 is preassembled by resting the hanging loop portion 60 of the flexible elastic loop 16 upon the ribs 50 of the first flange 32 or second flange 34. The first flange 32 and second flange 34 are engaged by inserting the tabs 40 of the first flange 32 into the receptacles 42 of the second flange 34 and snapping the flanges together, thereby forming the interior cavity 39 between the flanges and securing the hanging loop portion 60 within the interior cavity 39. The base 14 is then mounted to a wall 70 or other surface by inserting the fastener 30 through the axial aperture 26 of the post 24 and into the wall 70, as shown in FIG. 2. Optionally, the base 14 may be mounted to the wall 70 or other surface by applying pressure sensitive tape 80 between the backing 22 of the base 14 and the wall 70, as shown in FIG. 8.

To bundle the cables 12, the tightening loop portion 62 is wrapped circumferentially around the desired configuration of cables, as shown in FIG. 7. The grooved collar 20 is then inserted through the tightening loop portion 62, thereby closing the pair of aligned, closed support loops 66 circumferentially around the bundle of cables 12 in a slipknot configuration 64. The grooved collar 20 is then slid onto the post 24 of the base 14, thereby securing the bundled cables 12 to the wall 70. Optionally, as shown in FIG. 9, the cable management apparatus 10 may be used to bundle cables 12 and secure the bundle of cables 12 to furniture 100, such as a cabinet or a desk.

The primary advantage of the present invention is the ease of operation. As described herein, cables 12 may be selectively bundled by simply wrapping the flexible elastic loop 16 around the bundle and threading the collar 20 through the tightening loop portion 62 to hold the bundle of cables 12 in place. The grooved collar 20 is then easily slid onto the base 14 for hanging the bundle of cables 12 from a wall, furniture, or any other surface.

Another advantage of the present invention is the ability to easily add and remove cables 12 to and from the bundle. For example, as previously discussed, bundling the cables 12 and hanging the bundle from any surface is a simple, fast, and straightforward process. Therefore, as will be appreciated, adding or removing a cable to or from a bundle may be easily and quickly achieved. This is advantageous when adding a new electronics device to an existing system, or when removing a device from the system.

Yet another advantage of the present invention is the ability to obscure cables 12 from view when mounted to an irregular shaped cabinet. In particular, unlike cable tracks, which are linear and stiff, a series of bases of the present invention can be mounted along irregular surfaces of furniture at any desired location. Similarly, the present invention can be used to hang a bundle of cables 12 from a wall at various points of curvature along the wall or other surface.

Although this invention has been shown and described with respect to the detailed embodiments thereof, it will be understood by those skilled in the art that various changes in form and detail thereof may be made without departing from the spirit and the scope of the invention. For example, the present invention could function without the grooved collar 20 by providing a hook on the post 24 and hanging the hanging loop portion 60 of the flexible elastic loop 16 directly on the hook. Furthermore, although the base 14 of the present invention has been described as mounted by a fastener or tape, any available means of attaching the base 14 to a surface could be employed. For example, hook and loop fasteners or glue could secure the base 14 to a surface. In addition, although the grooved collar 20 has been described as a two-part assembly, it will be appreciated that the grooved collar 20 could be provided as a single integral unit. Moreover, it will be appreciated that the flexible elastic loop 16 could be provided in the form of a rubber band or a continuous bungee cord. Therefore, these and other changes in form and detail are covered by the claims appended hereto in order to encompass the true spirit and scope of the present invention.

What is claimed is:

1. A cable management apparatus comprising:
a base mountable on a surface; and
a flexible elastic loop adapted to support at least one cable extending therethrough having a hanging loop portion adapted to hang on said base.

2. The cable management apparatus of claim 1, wherein said base includes a post extending outwardly therefrom and said hanging loop portion is adapted to hang from said post.

3. The cable management apparatus of claim 2, comprising a removable grooved collar surrounding said post and slidably received thereon.

4. The cable management apparatus of claim 3, wherein said hanging loop portion of said elastic loop is received within said grooved collar.

5. The cable management apparatus of claim 3, wherein said grooved collar comprises a first flange and a second flange substantially opposite from said first flange and spaced therefrom to define an interior cavity.

6. The cable management apparatus of claim 5, wherein said second flange includes one or more receptacles adapted to receive one or more tabs extending from said first flange.

7. The cable management apparatus of claim 5, wherein said first flange and said second flange each include one or more ribs for supporting said hanging loop portion within said interior cavity.

8. The cable management apparatus of claim 5, wherein said first flange is ultrasonically welded to said second flange.

9. The cable management apparatus of claim 1, wherein said flexible elastic loop is adapted to tie in a slipknot configuration comprising a pair of aligned, closed support loops through which the at least one cable is received.

10. The cable management apparatus of claim 9, further comprising a tightening loop portion surrounding said pair of support loops and tying said pair of support loops in alignment with one another circumferentially around the at least one cable.

11. The cable management apparatus of claim 1, comprising a pressure sensitive adhesive for adhering said base to a surface.

12. The cable management apparatus of claim 2, wherein said post includes an aperture adapted to receive a fastener therethrough for securing said base to a surface.

13. The cable management apparatus of claim 12, wherein said fastener is a screw.

14. A cable management apparatus comprising:
a plurality of bases mountable on a surface, with each base having a post extending outwardly therefrom;
a plurality of removable grooved collars surrounding each post and slidably received thereon; and
a plurality of flexible elastic loops having hanging loop portions supported within each grooved collar and adapted to support at least one cable extending therethrough.

15. The cable management apparatus of claim 14, wherein each collar comprises a first flange and a second flange substantially opposite from said first flange and spaced therefrom to define an interior cavity.

16. The cable management apparatus of claim 15, wherein said second flange includes one or more receptacles adapted to receive one or more tabs extending from said first flange.

17. The cable management apparatus of claim 15, wherein said first and second flange include one or more ribs for supporting said hanging loop portion within said interior cavity.

18. The cable management apparatus of claim 14, wherein said grooved collar is an integral collar formed around said hanging loop portion.

19. The cable management apparatus of claim 14, wherein each flexible elastic loop is adapted to tie in a slipknot configuration to support said at least one cable therein.

20. A cable management apparatus comprising:
a base mountable on a surface;
a post extending outwardly from said base;
a removable grooved collar surrounding said post and slidably received thereon; and
a flexible elastic loop received within said grooved collar and adapted to support at least one cable extending therethrough.

21. The cable management apparatus of claim 20, wherein said grooved collar comprises a first flange and a second flange substantially opposite from said first flange and spaced therefrom to define an interior cavity, said interior cavity adapted to receive a portion of said flexible elastic loop.
